(19) United States
(12) Patent Application Publication
(10) Pub. No.: US 2009/0165744 A1
(43) Pub. Date: Jul. 2, 2009

(54) PULLING ROD ENGINE

(76) Inventors: Manousos Pattakos, Nikea Piraeus (GR); Efthimios Pattakos, Nikea Piraeus (GR); Paraskevi Pattakou, Nikea Piraeus (GR); Emmanouel Pattakos, Nikea Piraeus (GR)

Correspondence Address: Manousos PATTAKOS, Lampraki 406, Nikea Piraeus, 18452GR, GR

(21) Appl. No.: 12/162,357

(22) PCT Filed: Jan. 28, 2007
(86) PCT No.: PCT/EP2007/050809

§ 371 Date: Jul. 28, 2008

(30) Foreign Application Priority Data
Jan. 30, 2006 (GR) 20060100048
Mar. 1, 2006 (GR) 20060100131

(51) Int. Cl. F16C 7/00

(52) U.S. Cl. 123/197.3

(57) ABSTRACT

The piston is connected to the crankshaft via a connecting rod, while the crankshaft is disposed between the wrist pin and the combustion chamber. This way the combustion is shifted to the slow dead center, enabling the diesel to perform at higher revs, improving the spark engine efficiency and making HCCI combustion easier. Though the crankshaft is of one piece, more connecting rods can be used for a piston. As opposed piston, the PRE engine further combines top specific power, top thermal efficiency, built in scavenging pumps, and compactness.

In U.S. Pat. No. 6,062,187, U.S. Pat. No. 6,763,796 and U.S. Pat. No. 6,786,189 patents, which are the closest prior art, the objective is to increase the thermal efficiency by increasing the degree of constant volume of a fuel-air mixture at the time of combustion.

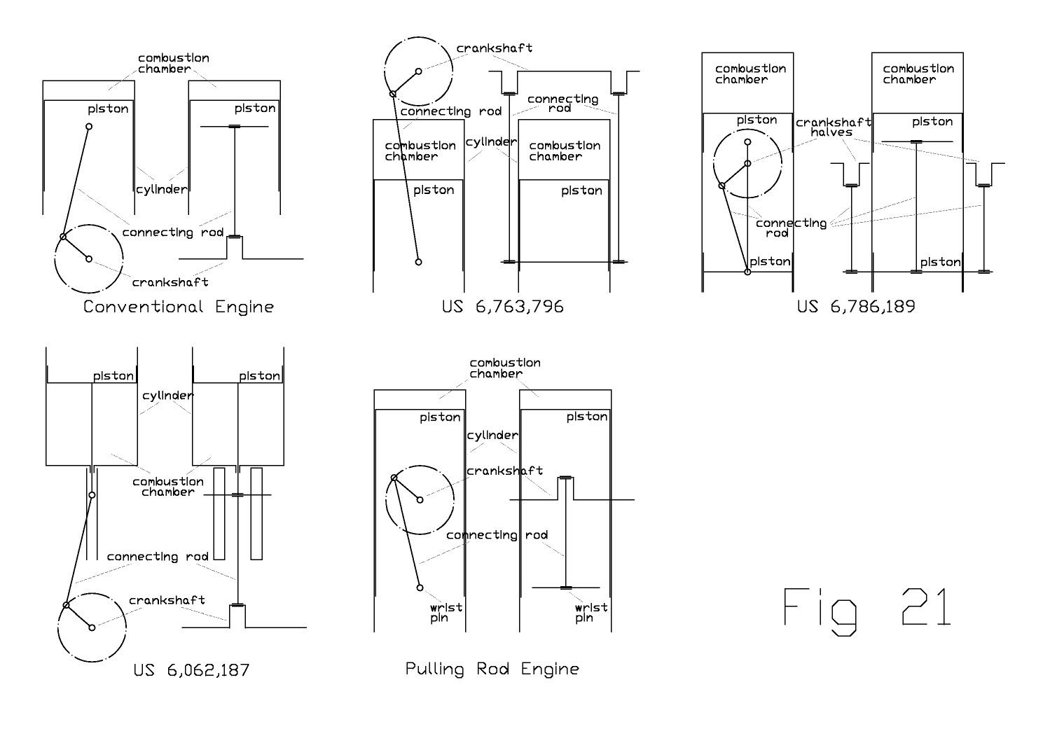

FIG. 21 contrasts the Conventional Engine to the closest prior art and to the present invention. In U.S. Pat. No. 6,062,187 the combustion chamber is disposed between the wrist pin and the piston. U.S. Pat. No. 6,763,796 patent claims a ‘combustion chamber/cylinder head’ disposed between the crankshaft and the piston. U.S. Pat. No. 6,786,189 patent shatters the unity of the crankshaft and compromises with synchronized ‘crankshaft halves’ disposed outside of the piston sliding path. In Pulling Rod Engine, or PRE, the crankshaft is disposed between the combustion chamber and the wrist pin.

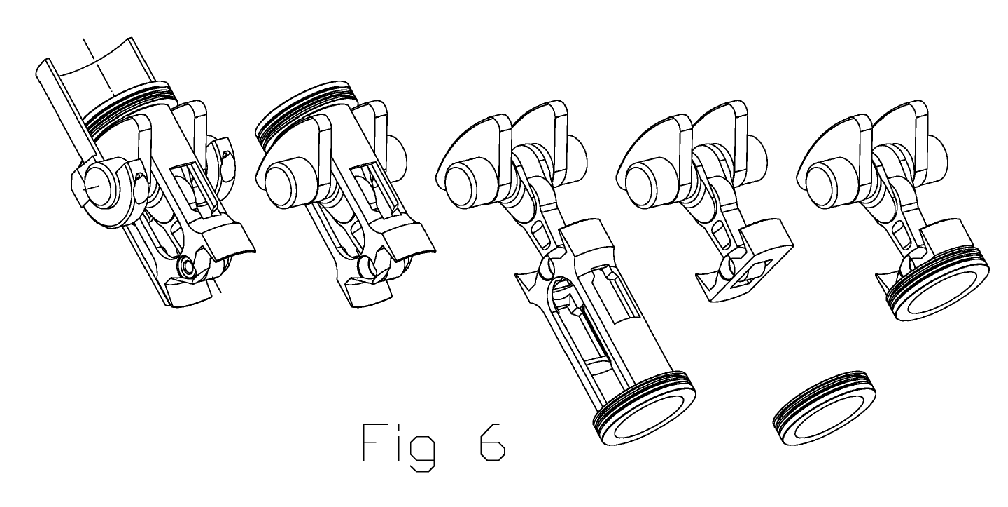

FIG. 6 shows, from left to right, the transition from the proposed arrangement to the conventional. At left the engine is assembled, then the cylinder—casing is removed, then the piston is rotated for 180 degrees about its wrist pin, and finally the piston shrinks in length to result the conventional mechanism, as shown at right most. This way the combustion shifts from the fast ‘dead center’ to the slow ‘dead center’.

As in the conventional, at one end the connecting rod of the PRE is attached to a crank pin of a crankshaft, while at its other end it is attached, by a wrist pin, to a reciprocating member or piston. In contrast to conventional, the crankshaft of the PRE is disposed in between the combustion chamber and the wrist pin.

An object of the present invention is to improve the combustion by increasing the degree of constant volume of a fuel-air mixture at the time of combustion, i.e. by providing more time, at good conditions, to the mixture to get prepared and burned.

Another object is to combine the simplicity of the conventional engine with the efficiency of the mechanisms proposed in the closest prior art.

Another object is to propose some PRE arrangements suitable for specific applications.

Despite its simplicity, the proposed solution is non obvious. This becomes obvious looking at the solutions proposed in the closest prior art patents, where a pair of crankshaft halves, geared to each other, a pair of long length connecting rods, a long piston pin etc are necessary for every piston.

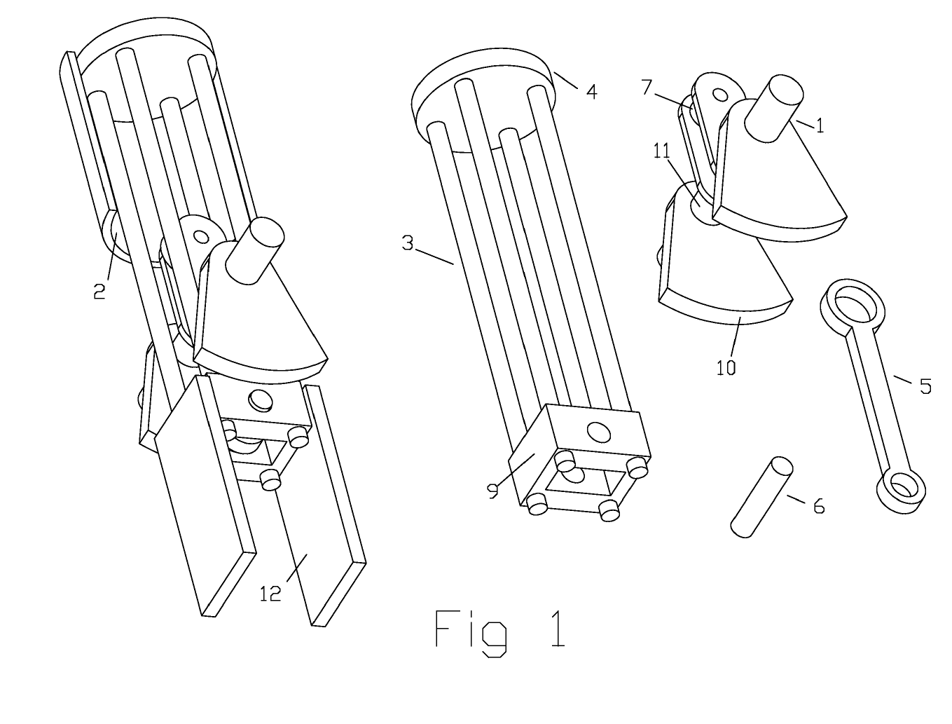

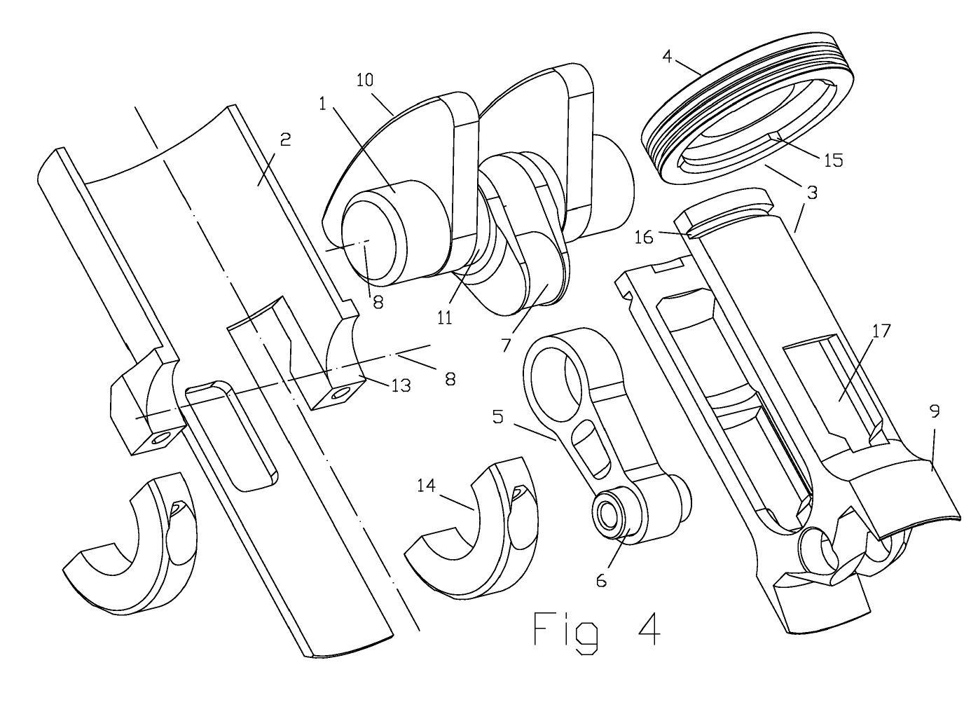

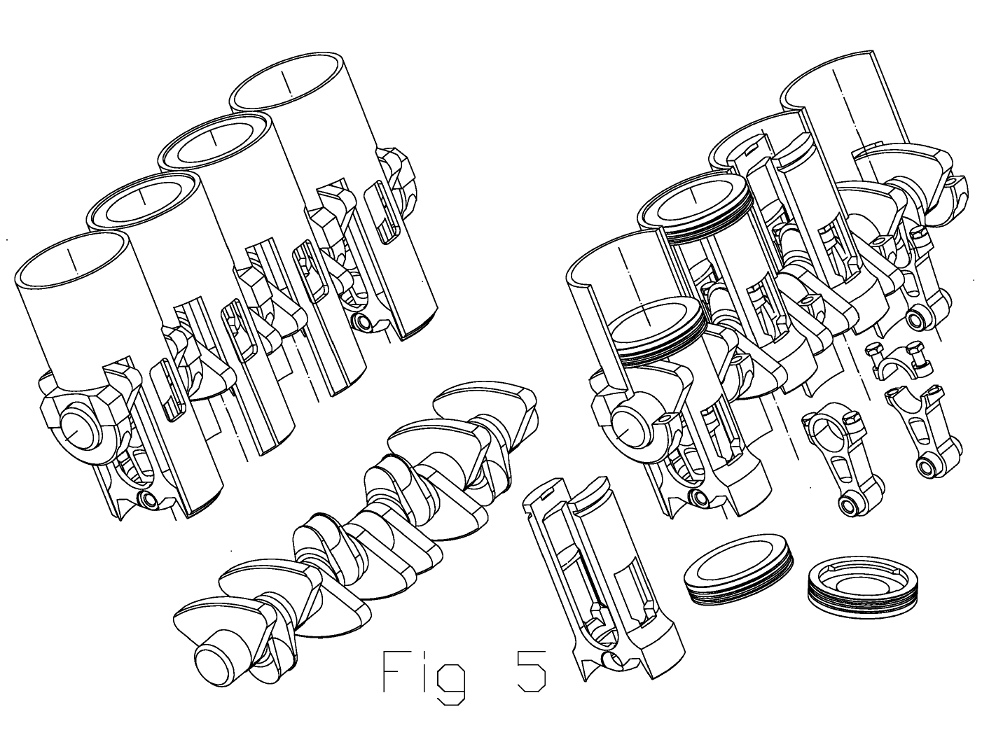

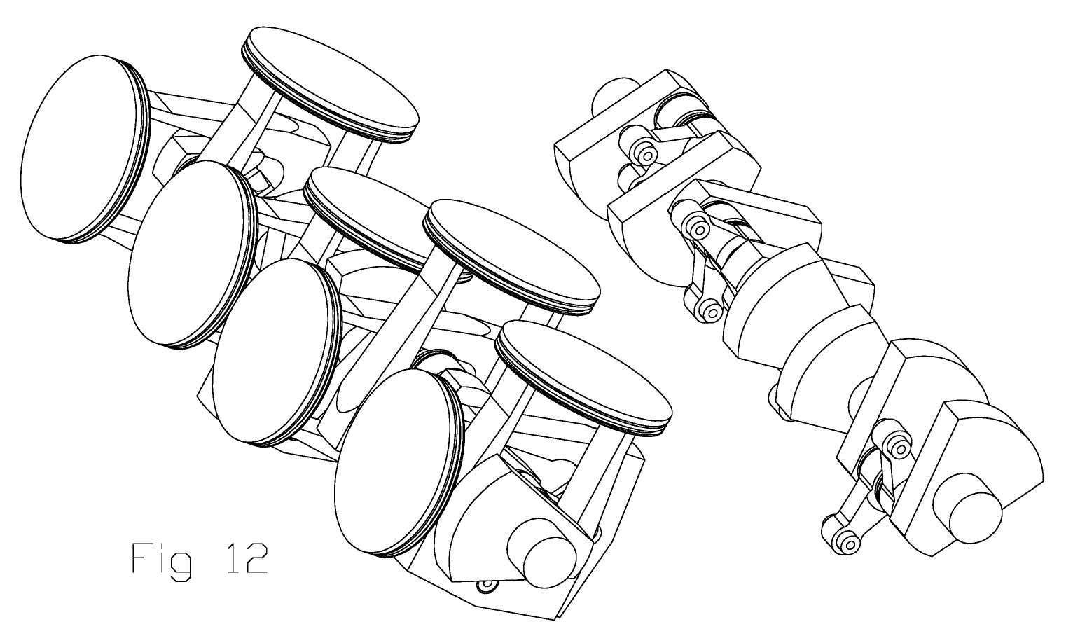

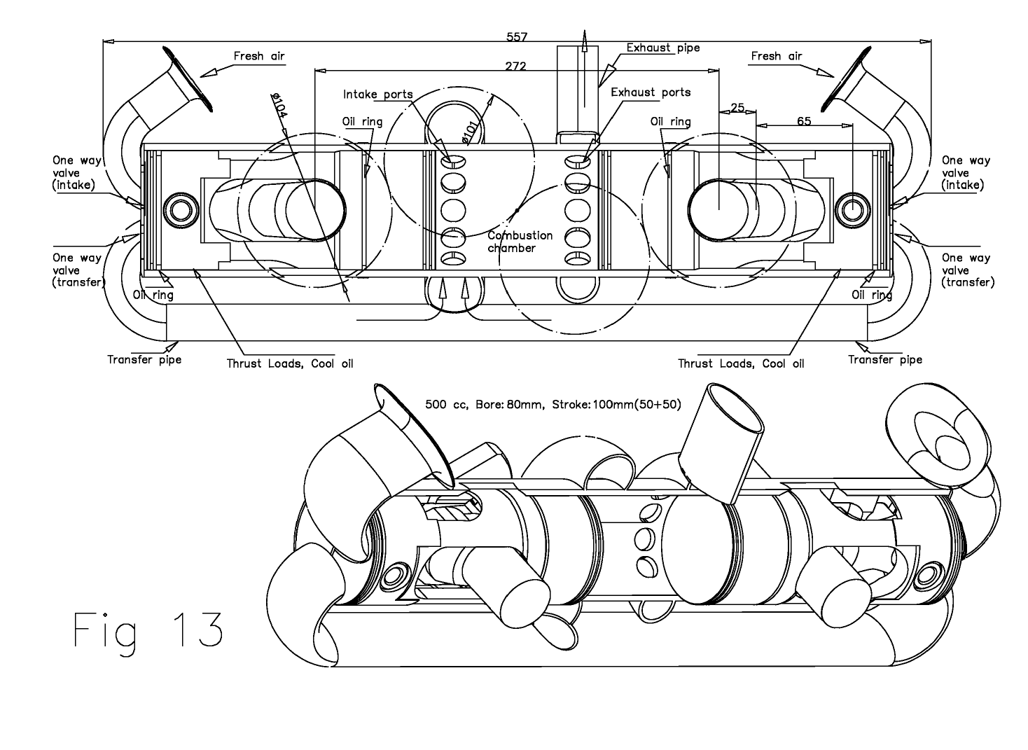

In FIGS. 1 to 12, (1) is the crankshaft, (2) is the cylinder, (3) is the piston, (4) is the piston crown, (5) is the connecting rod, (6) is the piston pin, (7) is the crankpin, (8) is the rotation axis of the crankshaft, (9) is the slider means for the thrust loads and (10) is a balancing web of the crankshaft. FIGS. 13 to 20 show the ‘opposed piston’ version and some applications.

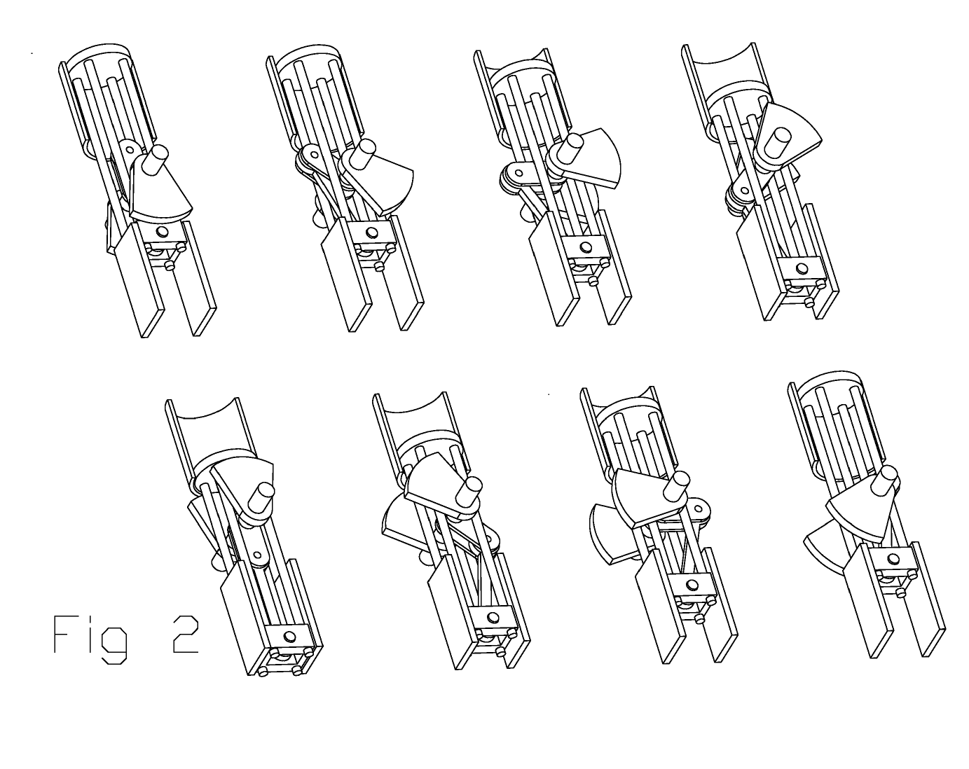

FIGS. 1 and 2 show the idea simplified.

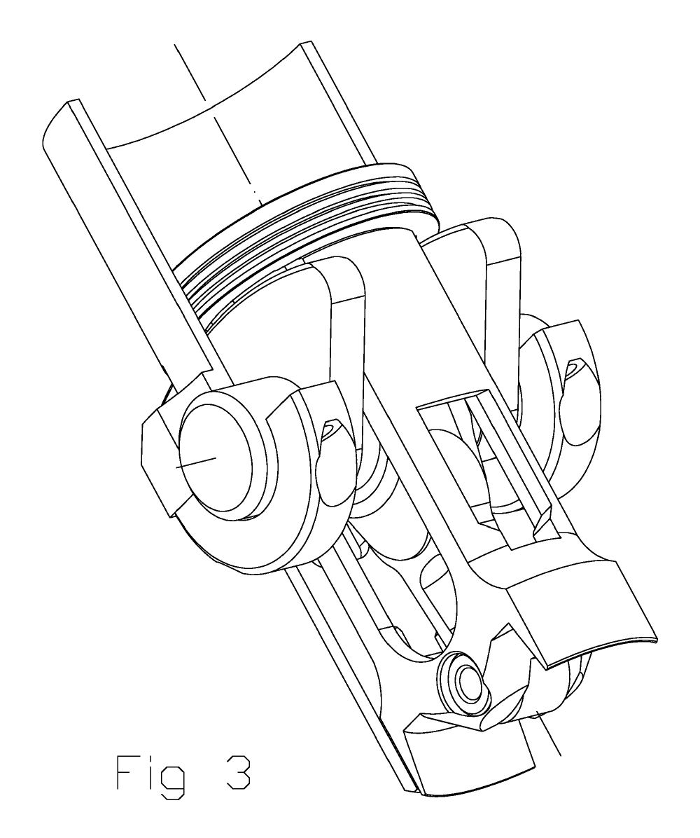

FIG. 3 to 6 show the application of the idea in a single and a four cylinder engine. The piston is made of two parts, for assembling reasons, locked to each other at (15) and (16). The piston body has slots (17) to allow the motion of the connecting rod. The piston has, at piston pin side, slider means (9) similar to the conventional piston skirt. The narrowing (11) of the crankshaft, between the crankpin (7) and the balancing web (10), allows reasonable dimensions, inertia and strength for the piston.

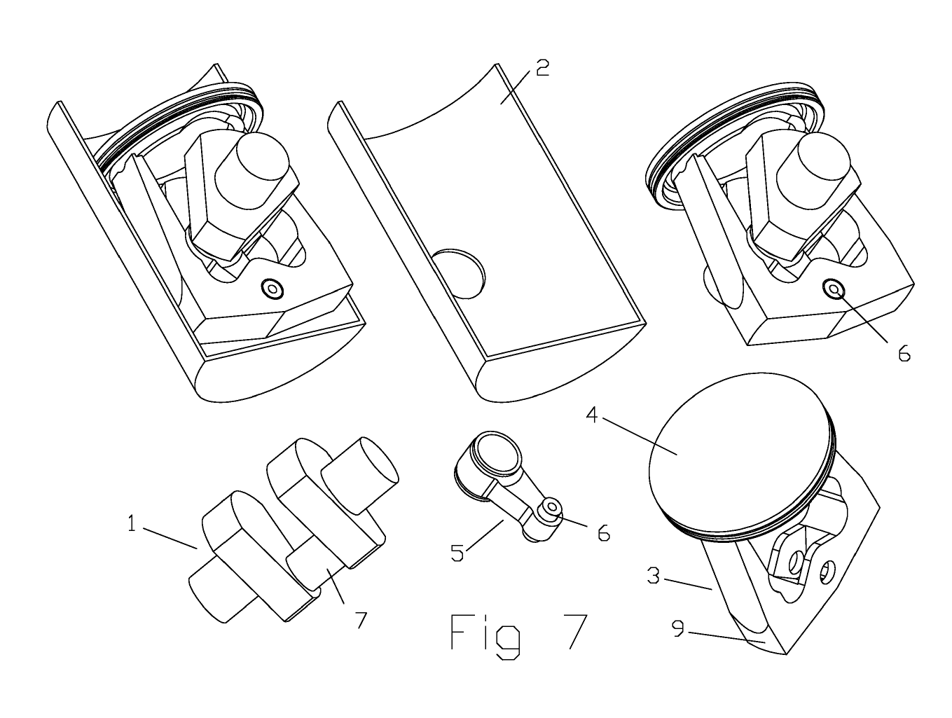

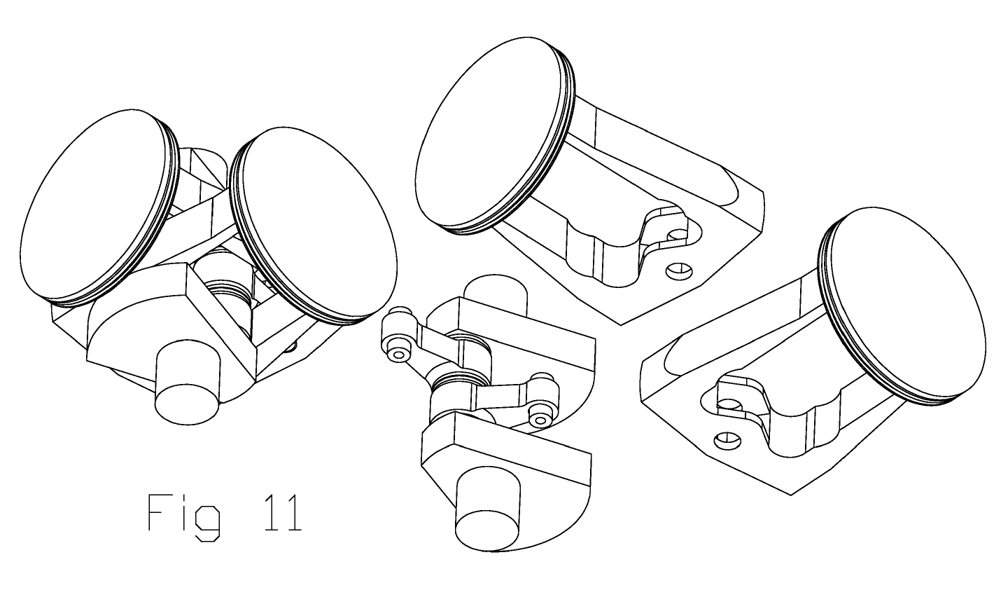

FIGS. 7 and 8 show another realization, applicable in short stroke engines, like racing. FIG. 11 shows a two cylinder V90 based on the same parts, while FIG. 12 shows the moving parts of an eight cylinder V90 engine.

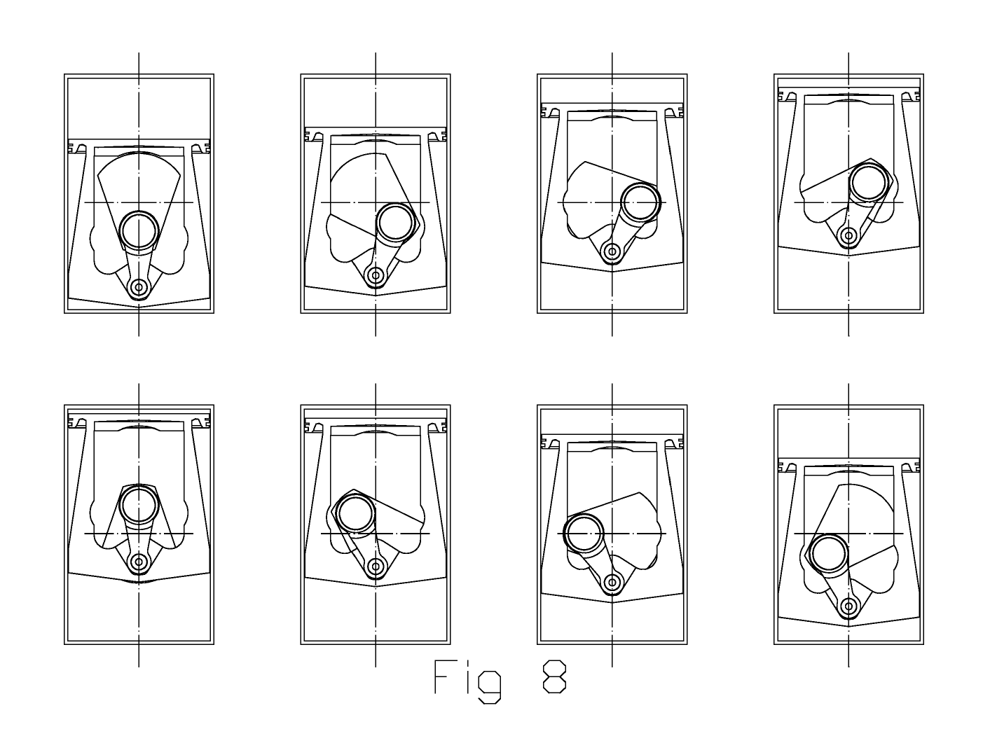

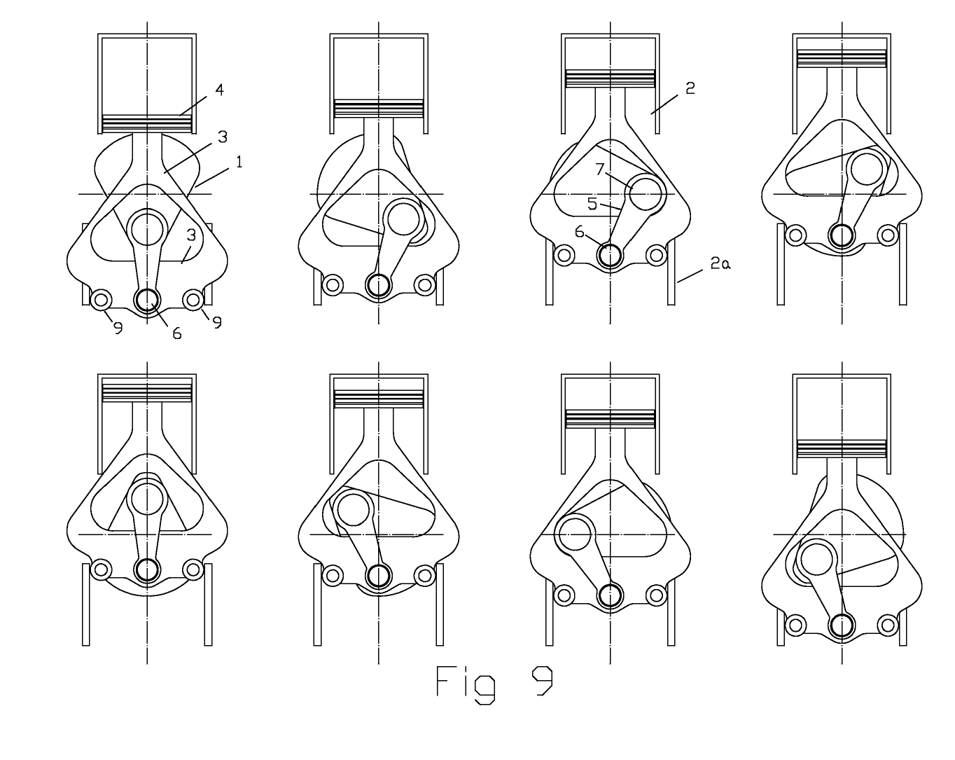

For longer stroke the piston of FIG. 7 can be modified to that shown in FIG. 9, where the triangular shape provides rigidity and lightweight. In FIG. 9 the thrust loads are carried by rollers (9).

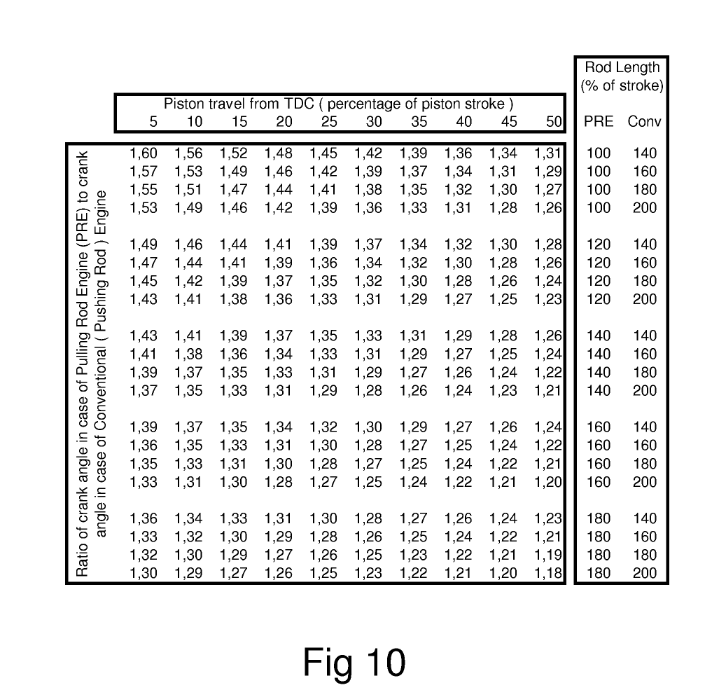

The significance of the connecting rod length, in terms of the additional time the piston dwells close to Top Dead Center, becomes clear by the table in FIG. 10. Using short connecting rod and operating the pulling rod engine at around 5500 rpm the working medium feels, in terms of time—volume conditions, like being burned inside a long rod conventional engine revving at 4000 rpm (5600=1.4*4000). On this basis the power concentration, especially of Diesel and natural gas engines, can significantly rise.

Although the piston is longer, the engine can be shorter and the distance between cylinder head and crankshaft can be significantly smaller compared to the conventional of same stroke.

Lower compression ratio can be used to reduce parts' stress, especially for Diesels, without reducing the efficiency, because what counts is not the nominal compression ratio but the average compression ratio during combustion.

Racing engines' robustness, compactness and power output can be improved.

A shorter connecting rod is lighter, more rigid, proper for higher revs and provides more time for the combustion. The gas pressure on the piston crown and the maximum inertia force load the connecting rod only in tension.

The thrust loads are transferred to the casing not at the hot cylinder wall near combustion chamber, but at the other end of the piston, with either traditional slider means or rolling means etc. The clearance and the lubrication in this area of the piston is easier to control and more reliable, providing more suppression of the impact loads from combustion and inertia forces. In case of using short or very short connecting rod, the additional thrust loads are small price, in terms of mechanical friction and vibration, compared to the gains from the improved combustion.

The ‘opposed piston’ PRE of FIGS. 13 to 20 achieves autarkic and efficient operation with less weight and bulk. The thermal efficiency is increased by increasing the degree of constant volume of the working medium at the time of combustion. The additional time at high compression can shift the efficient combustion rev limit higher, especially for the compression ignition engines, thereby increase the power concentration. The pistons have crowns on both ends. The distal, from engine's center, crowns, in cooperation with one way valves, create the scavenging pumps or the compressors at the edges of the engine, while the other crowns form the combustion chamber at the center, achieving through scavenging. The two short stroke opposite pistons generate a long central cylinder and consequently a compact and efficient combustion chamber. Each crankshaft is disposed between its mate wrist pin and the combustion chamber. Obviously, the wrist pins can be located at the other side of the pistons, i.e. at the side of the combustion crown, but this shortens the time available for an efficient combustion.

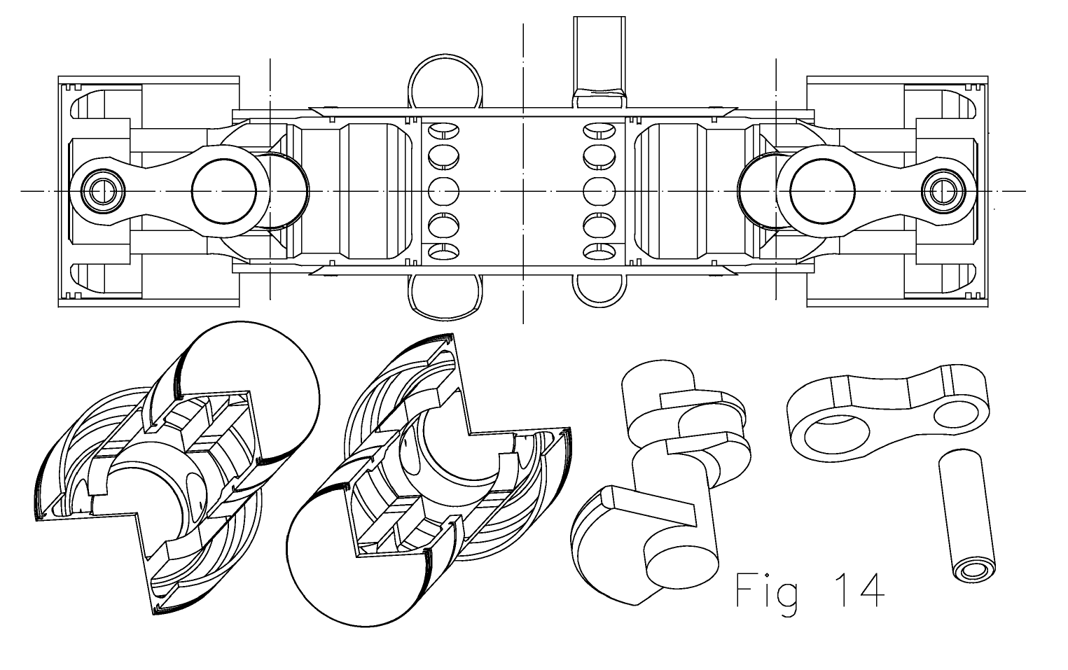

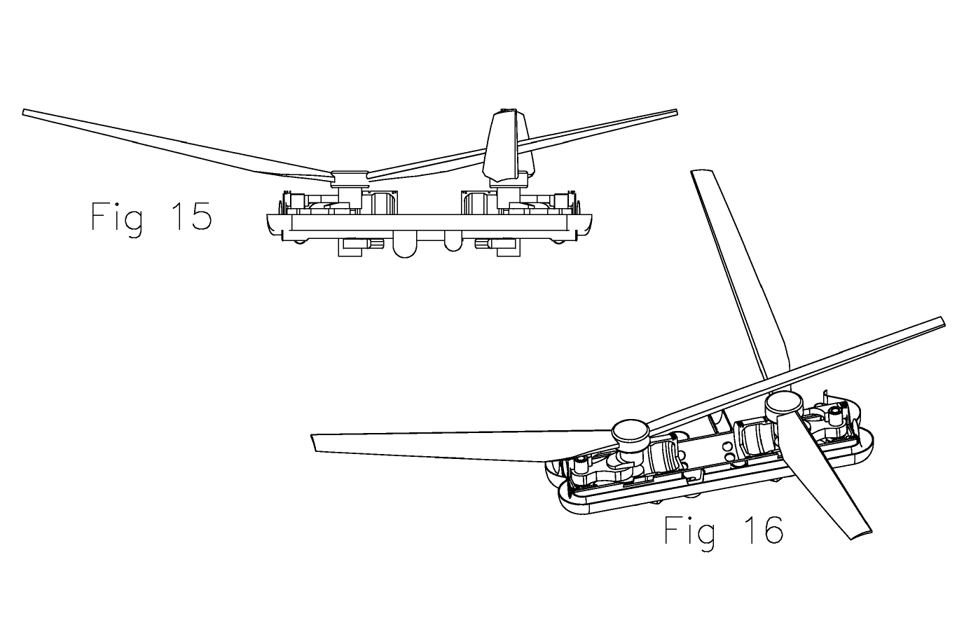

In FIGS. 15 and 16 each one of the two opposite rotating, in synchronization, crankshafts drives a rotor/helix with inclined blades to form a portable flying machine. Rotors with inclined blades are still unconventional.

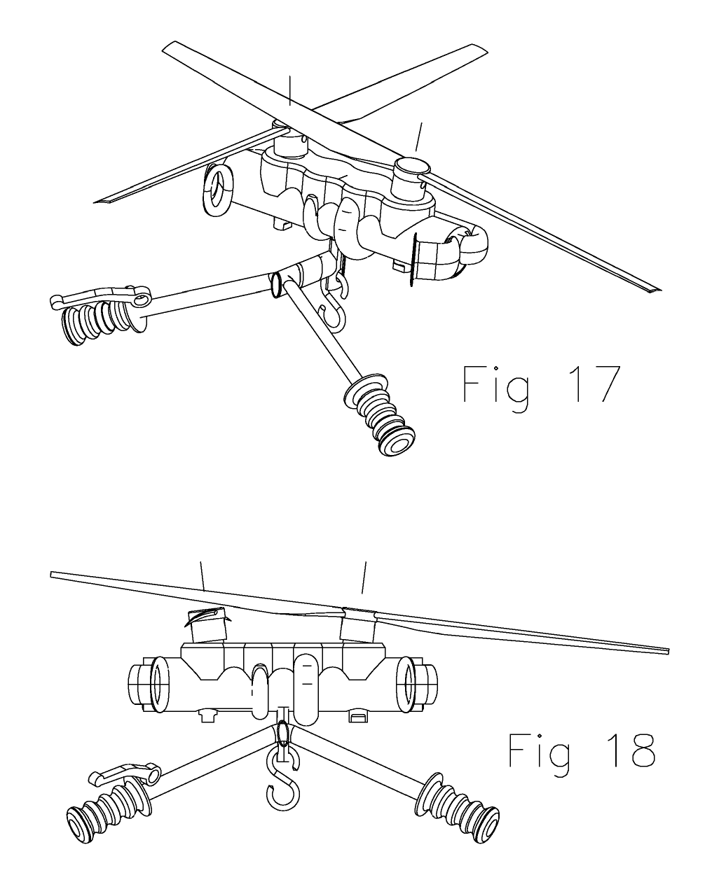

In FIGS. 17 and 18 the opposed piston PRE drives two conventional rotors. Each rotor is connected to its mate crankshaft by means of a constant speed, or Cardan, connection and is rotatably mounted on the casing of the engine at a small inclination compared to its mate crankshaft axis. This way the two, parallel and close to each other, crankshafts drive two ‘inclined’ large diameter conventional rotors without collision. This arrangement seems ideal for portable flying machines.

In the flying machines of FIGS. 15 to 18, the flyer/pilot keeps control by changing the revs/load of the engine and by displacing his body with respect to the engine/rotors set. The motion can be from pure hovering to airplane like flight. There is no torque from the rotors to compensate, there are neither inertia nor combustion vibrations and the noise is suppressed because the blades only gradually sweep one over the other. Animations can be found at www.pattakon.com web site.

The crux of a portable flyer has always been the weight of the prime mover, the resulting reaction torque, the vibrations and the consumption. To allow for flights at higher altitudes, or to just supercharge the opposed piston PRE, the diameter of the compressor crown can increase, as in FIG. 14, to compensate for the drop of the air density. The absence of camshafts, of timing belts, of poppet valves etc makes the engine reliable and light. With the two rotors having similar resistance in rotation, the four synchronizing gears, shown by the dashed dot circles in FIG. 13, remain almost unloaded.

The systems shown in FIGS. 15 to 18 can also be used as the propulsion system of airplanes and helicopters, releasing the body of the aircraft from vibrations and reaction torque. It is obvious that the piston crowns need not be of the same size, that one piston can be conventional or just a sleeve valve and that the through scavenging is just an option.

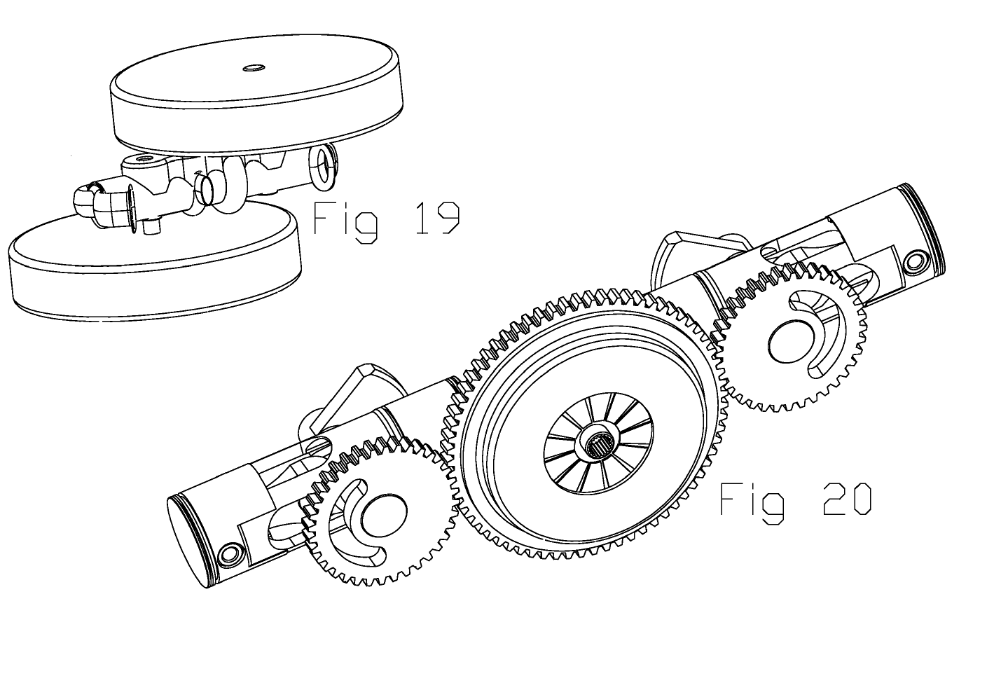

Replacing the two rotors of FIGS. 15 to 18 by two electric generators, an inertia vibration free and combustion vibration free electric power plant can result, as shown in FIG. 19, for hybrid cars, vibration sensitive applications, stationary applications etc.

FIG. 20 shows another opposed piston PRE arrangement applicable on bikes, cars, trucks etc. The two crankshafts rotate in synchronization at the same direction by means of the central spur gear. The power flows from the two crankshaft to the central spur gear and then, through the clutch, to the gearbox or load.

Although the invention has been described and illustrated in detail, it is to be clearly understood that the same is by way of illustration and example, and is not to be taken by way of limitation. The spirit and scope of the present invention are to be limited only by the terms of the appended claims.

1. A reciprocating internal combustion engine, comprising at least:
a cylinder;
a crankshaft;
a piston slidably fitted in said cylinder, said piston seals one side of a combustion chamber;
a connecting rod, said connecting rod being attached to said piston at a wrist pin, said connecting rod being attached to said crankshaft at a crankpin, the crankshaft is disposed between the wrist pin and the combustion chamber to shift the combustion from the fast dead center to the slow dead center, maintaining the simplicity of the conventional engine, keeping the unity of the crankshaft, without dividing it into crankshaft halves.

2. As in claim 1 wherein the crankshaft runs through the piston.

3. A reciprocating internal combustion engine, comprising at least:
a crankshaft (1);
a cylinder (2);
a piston (3) slidably fitted in said cylinder (2), said piston (3) having a piston crown (4), said piston crown (4) seals one side of a combustion chamber;
a connecting rod (5), said connecting rod (5) being attached to said piston (3) at a piston pin (6), said connecting rod (5) being attached to said crankshaft (1) at a crankpin (7),
characterized in that the crankshaft is disposed between the combustion chamber and the piston pin to shift the combustion from the fast to the slow dead center, maintaining the unity of the crankshaft.

4. As in claim 3 wherein the center of the piston pin (6) moves exclusively at the opposite, to the combustion chamber, side of the rotation axis (8) of the crankshaft (1).

5. As in claim 3 wherein the crankshaft (1) is a one piece crankshaft and the piston (6) is kinematically coupled to exclusively one crankshaft.

6. As in claim 3 wherein the piston (3) has, at its opposite to its piston crown (4) side, a second piston crown, said second piston crown seals a second compression or combustion chamber.

7. As in claim 3 wherein a second crankshaft rotates in synchronization to the crankshaft (1), a second piston is attached to the second crankshaft by a second connecting rod, the piston (3) and the second piston seal the two sides of a combustion chamber to form an opposed piston pulling rod engine.

8. As in claim 3 wherein a second crankshaft rotates in synchronization to the crankshaft (1), a second piston is attached to the second crankshaft by a second connecting rod, the piston (3) and the second piston seal the two sides of a combustion chamber to form an opposed piston pulling rod engine, the piston (3) and the second piston have secondary piston crowns forming the scavenging pumps of the engine.

9. As in claim 3 wherein the crankshaft (1) comprises a balancing web (10) and a narrowing (11), said narrowing (11) is disposed between the crankpin (7) and the balancing web (10) to allow a rigid and compact connection of the two piston ends.

10. A reciprocating internal combustion engine resulting from the conventional ‘reciprocating member to connecting rod to crankshaft’ mechanism by rotating the reciprocating member, about its pivotal join with the connecting rod, for half a turn and by disposing the crankshaft between the combustion chamber, which is sealed at one side by the reciprocating member, and the pivotal join of the reciprocating member with the connecting rod,
thereby the combustion is transferred, in a simple and functional manner, at the slow ‘dead center’ of the engine, providing more time at better conditions to the mixture or spray to get prepared and burned.
